(19) United States
(12) Patent Application Publication
(10) Pub. No.: US 2015/0053178 A1
(43) Pub. Date: Feb. 26, 2015

(54) COMBUSTION MODIFICATION AND EMISSIONS REDUCTION UTILIZING AN ELECTRICALLY INSULATED ENGINE MEMBER IN INTERNAL COMBUSTION ENGINES

(71) Applicant: Wayne State University, Detroit, MI (US)

(72) Inventors: Fadi A. Estefanous, Warren, MI (US); Naeim A. Henein, Grosse Pointe Farms, MI (US)

(21) Appl. No.: 14/388,376

(22) PCT Filed: Mar. 28, 2013
(86) PCT No.: PCT/US13/34231

§ 371 Date: Sep. 26, 2014

Related U.S. Application Data
(60) Provisional application No. 61/617,125, filed on Mar. 29, 2012.

(51) Int. Cl. F02P 9/00

(52) U.S. Cl. CPC F02P 9/002
USPC 123/406.19; 123/406.12

(57) ABSTRACT

A system and method is provided for applying an electric field in internal combustion engines to act on the combustion process to reduce emissions and improve fuel economy in an engine. The engine has an engine block forming a combustion chamber. An in-cylinder engine part is exposed within a combustion chamber of the engine and a voltage is applied between the in-cylinder engine part and the engine block.

### BACKGROUND

### Field of the Invention

The present application is related to a system and method for reducing emissions formation and improving the efficiency of an internal combustion engine.

### SUMMARY

A system and method is provided for reducing emission formation and improving the efficiency of an engine. The engine has an engine block forming a combustion chamber. An in-cylinder electrically insulated engine part is exposed within a combustion chamber of the engine and a voltage is applied between the in-cylinder engine part and the engine block.

Further objects, features and advantages of this application will become readily apparent to persons skilled in the art after a review of the following description, with reference to the drawings and claims that are appended to and form a part of this specification.

### BRIEF DESCRIPTION OF THE DRAWINGS

Aspects of this application will be described by way of examples with reference to the accompanying drawings. They serve to illustrate several aspects of the present application, and together with the description provide explanation of the system principles. In the drawings:

FIG. 1 is an engine system for controlling engine operating parameters;

FIG. 2 is a schematic illustrating an insulated engine part that is provided a supply voltage with respect to the engine block;

FIG. 3 is a graph illustrating the soot reduction achieved by the techniques described in this application;

FIG. 4 is a graph illustrating the improvement of the rate of heat release due to the techniques described in this application; and

FIG. 5 is a graph illustrating the soot emissions for multiple cycles where every other section employed the techniques described herein.

### DETAILED DESCRIPTION

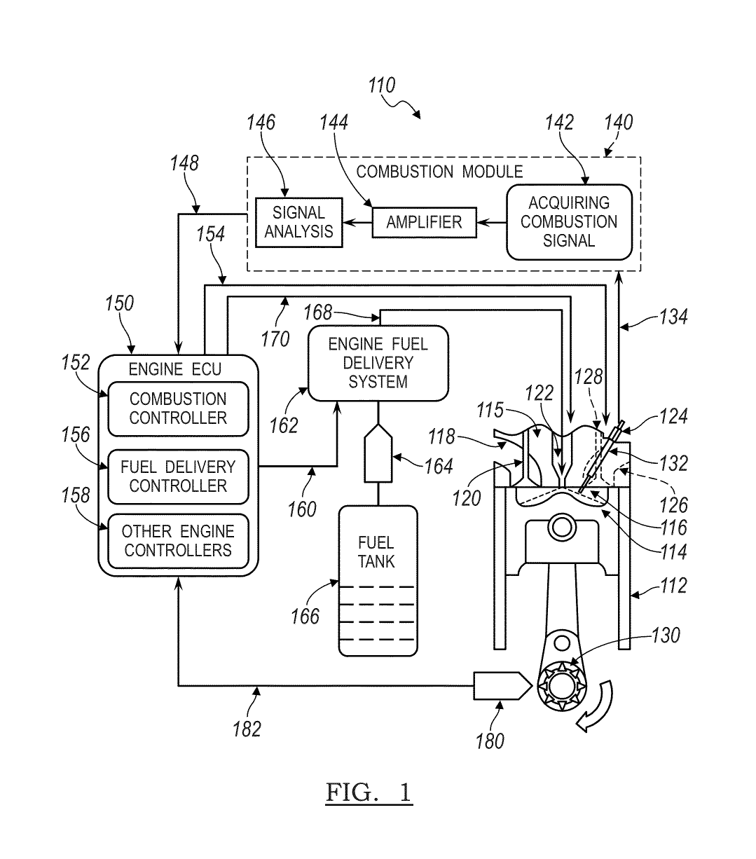

Now referring to FIG. 1, a schematic view of an engine 110 is provided. For illustrative purposes the schematic shows a single cylinder of an engine, however, it is readily understood that multiple cylinders may be used in combination to form the engine. The cylinder 112 houses piston 114 allowing for reciprocating motion of the piston 114 within the cylinder 112. The combustion chamber 116 is formed by the cylinder houses 112, the piston 114, and the cylinder head 115. Air, a mixture of air and exhaust gases, or other mixtures of any fluid may be provided into the chamber 116 through an intake manifold 118. The flow of air or mixtures made through the intake manifold 118 may be controlled by intake valve 120. Fuel may be provided into the chamber by a fuel injector 122. A spark plug 124 may is used to ignite of the fuel inside the combustion chamber 116 causing reciprocating motion of the piston 114. After combustion, the exhaust gases in the chamber may be released through the exhaust manifold 126. Further, the flow of exhaust may be controlled by an exhaust valve 128 located within the exhaust manifold 126. As may be readily understood, combustion in the chamber 116 causes the piston 114 to move downward causing rotation of the crankshaft 130. The inertia of a flywheel or combustion in other chambers will cause the crankshaft 130 to rotate further thereby causing a reciprocating motion of the piston 114 upward. The spark plug 124 can be turned on by the ECU 150 through an electrical command 154. The spark plug 124 may also include a sensor 132 to monitor activity within the combustion chamber 116 during the entire cycle of the engine. The sensor 132 includes an ion current sensor, a pressure sensor, an optical sensor, or any combination of the above. These sensors may be standalone or integrated with the spark plug or the fuel injector 122. Although certain aspects may be particularly useful for spark ignited engines, the application of this technology with regard to other internal combustion engines such as diesel engines is contemplated herein. In such scenarios, the ion current sensor may be placed within a glow plug. The sensor signal 134 may be provided to a combustion module 140. The combustion module 140 includes an acquisition module 142 for acquiring the combustion signal and amplifier 144 for enhancing the combustion signal and a signal analysis module 146 to determine certain combustion characteristics based on the enhanced combustion signal. The combustion parameters 148 are then provided to an engine control module 150. The engine control module 150 may then analyze the combustion parameters and control engine operation parameters based on the combustion parameters. In one implementation, the ion current signal may be used to control the engine operating parameters.

The engine control unit 150 includes a combustion controller 152, a fuel delivery controller 156 and other engine controllers 158. The combustion controller 152 may act as a master module that provides a control signal to different engine components such as the spark plug 124 (ignition system), the fuel delivery system 162, or the injector 122. The fuel delivery controller 156 provides a fuel delivery control signal 160 to an engine fuel delivery system 162. The engine fuel delivery system controls the delivery of fuel to the injector 122. The fuel from the tank 166 is delivered by the fuel pump 164 to the fuel delivery system 162. The fuel delivery system 162 distributes the supplied fuel based on a signal 160 from the ECU 150. The fuel is further supplied to the injector 122 through a fuel line 168. In addition, the fuel delivery controller 156 is in communication electronically with the fuel injector 122 to control different injection parameters such as number of injection events, injection duration and timing as noted by line 170. In addition, the other engine controllers 158 control other engine parameters such as engine speed, load, amount of exhaust gas recirculation, variable geometry turbocharger, or other units installed to the engine. Further, an output sensor 180 may be in communication with the crankshaft 130 to measure crank shaft position, and engine speed, torque of the crankshaft, or vibration of the crank shaft, and provide the feedback signal to the engine control unit 150 as denoted by line 182. One of the in-cylinder parts may be electrically isolated from the engine block. Multiple electrically isolated parts may also be added inside the combustion chamber. A voltage may be applied to the isolated in-cylinder part. The voltage may be an AC voltage with variable frequencies or DC voltage with variable voltage for example, greater than 500 volts, between 500 and 5000 volts, or between 1000 and 5000 volts. The electrically isolated in-cylinder part may be a glow plug, a fuel injector, valves, cylinder head, cylinder head gaskets, a spark plug, any ion sensor, a special purpose probe, or any combination from the list above. Other parts may be added to the engine cylinder such as two metal pieces could be electrically isolated and positioned inside the combustion chamber on the surface of the combustion bowl of a piston.

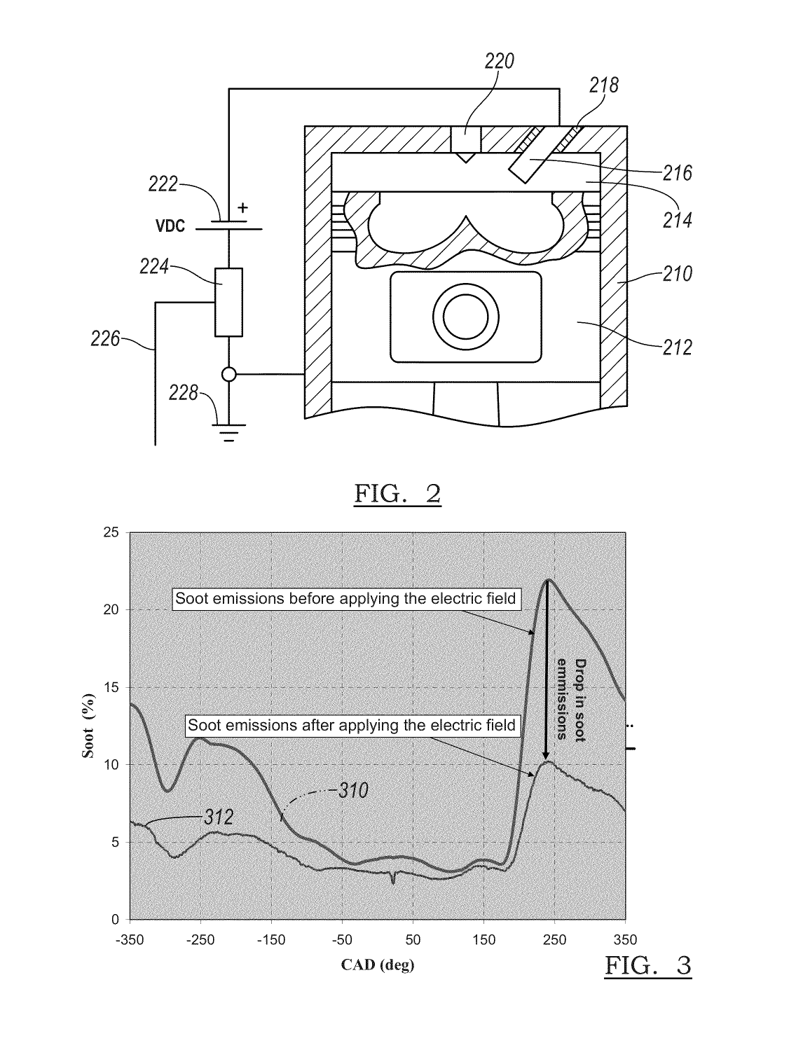

Now referring to FIG. 2, a schematic is provided for an example where a supply voltage is provided to an electrically isolated in-cylinder engine part with respect to the engine block. The engine block 210 includes a combustion chamber 214 and a piston 212. In this schematic the isolated in-cylinder engine part is a glow plug 216. The glow plug 216 is electrically insulated from the engine block 210 by an isolation material 218. The isolation material may be any dielectric material including for example high temperature resistance plastic, nylon, ceramic, nano-material or other nonconductive materials. While it is understood that the glow plug 218 may be used as the insulated in-cylinder part to provide the supply voltage, other parts may be isolated instead of or in addition to the glow plug 218 and provided the supply voltage. For example, the fuel injector 220 may be used as the insulated in-cylinder part to provide the supply voltage instead of or along with the glow plug 218. Similarly, other in-cylinder engine parts may be used along with or instead of the glow plug 218. For example, a spark plug, a valve, engine cylinder head, or even the special purpose probes.

The in-cylinder part may be connected to the positive terminal of a high voltage power supply 222. The high voltage power supply may provide a DC voltage greater than 500 volts, where in some instances, the high voltage power supply may provide a voltage between 500 to 5000 volts. The voltage used may be reduced with increased surface area of the isolated parts. The voltage may be a DC voltage which may provide direct current for all or part of the engine cycle. Further, the voltage may be an AC voltage with variable frequencies. In some implementations the voltage may be applied for 100 milliseconds and in other implementations the voltage may be applied for all or substantially all of the engine cycle. Further, it is understood that the engine controller may sense one or more engine parameters, such as ion current, pressure, temperature, crank angle, or other parameters discussed above to obtain a feedback signal. The engine controller may send a signal to the power supply to adjust the voltage type (AC or DC), voltage magnitude, voltage duration, voltage frequency, and/or voltage polarity based on the one or more sensed engine parameters.

The combustion chamber 214 of the engine block 210 may be connected to the negative terminal of the voltage supply 222. For example, the engine block 210 may be connected to the negative terminal of the power supply 222 through a load 224. The load 224 may be a voltage or current measurement device which then provides a measurement output 226 to a control unit. In addition, the engine block 210 may be connected to an electrical ground as noted by reference numeral 228. The high voltage signal provided to the isolated in-cylinder engine part will reduce the emissions formation and particularly reduce soot. In addition, this technique will also enhance the combustion process and improve fuel economy. The isolated in-cylinder part may be a glow plug, a fuel injector, valves, cylinder head, cylinder head gaskets, a spark plug, any ion sensor, a special purpose probe, a newly added part to the combustion chamber or any combination from the list above.

Providing the voltage to the in-cylinder engine part creates an electric field inside the combustion chamber. Small hydrocarbon ions are replaced by heavier hydrocarbon ions leading to soot formation in the engine. Controlling the ionized species location inside the combustion chamber using the electrical field prevents this loop of replacing the small hydrocarbon ions with the heavier hydrocarbon ions at an early stage. This is done by pushing small hydrocarbon ions away from their neutral reactants such as acetylene (C₂H₂). This favors the fuel decomposition and oxidation path rather than the fuel decomposition and soot formation path as shown below.

$$\begin{matrix}{CH}_{3}^{+} + {C}_{2} {H}_{2} ↔ {C}_{3} {H}_{3}^{+} + {H}_{2} & ( R 1 ) \\ {C}_{3} {H}_{3}^{+} + {C}_{2} {H}_{2} ↔ {C}_{5} {H}_{3}^{+} + {H}_{2} & ( R 2 ) \\ {C}_{5} {H}_{3}^{+} + {C}_{2} {H}_{2} ↔ {C}_{7} {H}_{5}^{+} & ( R 3 ) \\ … & \\ … & \\ … & \\ Soot Formation & ( {R}_{n} )\end{matrix}$$

Now referring to FIG. 3, a graph illustrating soot reduction using the above-described method is provided. The amount of soot produced is provided on the Y axis in percent of the total exhaust flow. The X axis represents time. The line 310 illustrates an average of 300 cycle of soot measured when zero volts is applied between the in-cylinder isolated engine part and the engine block. Line 312 illustrates an average of another 300 cycle of soot measured when 1000 DC volts is applied between the isolated in-cylinder part and the engine block. As illustrated in the graph, the soot production where 1000 DC volts was applied is noticeably less than the soot produced when zero volts is applied.

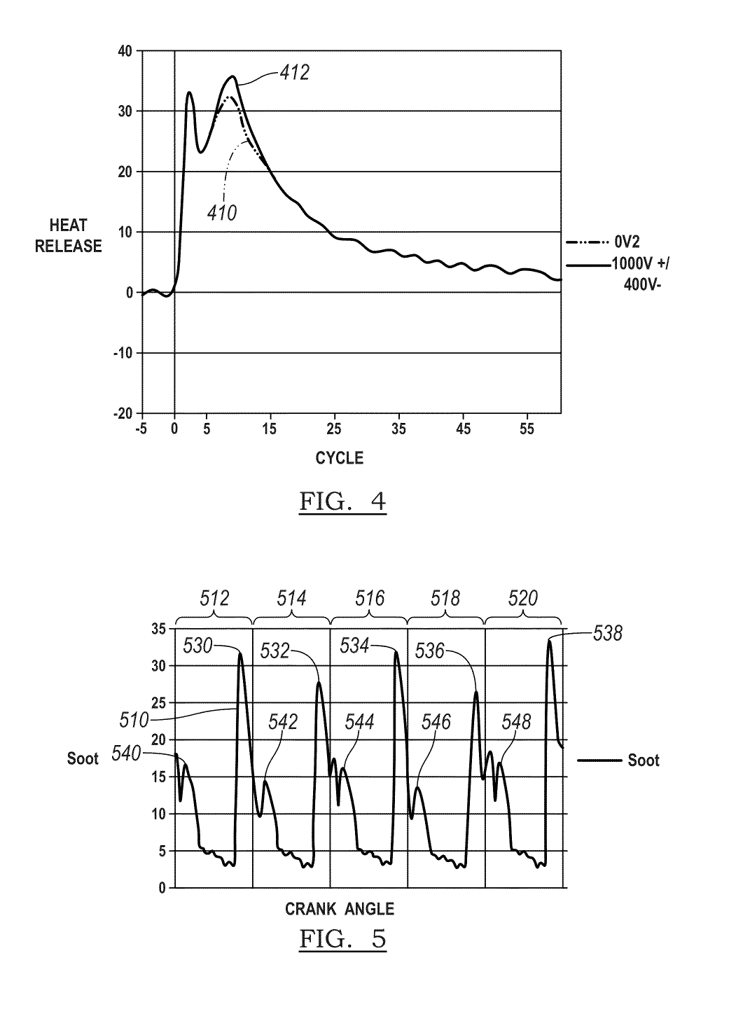

Now referring to FIG. 4, a graph illustrating the rate of heat release using the method of this application is illustrated. The rate of heat release is provided on the Y axis in joule/deg. The X axis represents crank angle degree (CAD). Line 410 illustrates an average of 300 cycles of the rate of heat release when there is a zero volt differential between the isolated in-cylinder part and the engine block. Line 412 illustrates an average of 300 cycles of the rate of heat release when 1000 volts DC is applied between the isolated in-cylinder part and the engine block. The difference between lines 410 and 412 illustrates that the electrical field applied on the engine provides an enhanced rate of heat release during the combustion cycle, which reflects more engine power gained from the same amount of fuel due to the effect of the new circuit.

Now referring to FIG. 5, a graph showing the comparison of the soot production during five sections of engine steady state operation where each section includes the average of 300 cycles. In every other section the voltage was applied aiding in the comparison of when the circuit was active to when the circuit was deactive. The amount of soot produced is provided along the Y axis in soot percent. The number of the crank angle for each section is provided along the X axis. Line 510 illustrates the in cycle soot production for the average of 300 cycles during steady state operation for each section. The only variable that was changed was to activate or deactivate the soot reduction circuit within each of the sections. In this graph, the soot reduction circuit was not active showing higher soot emissions in the first section 512. The second section 514 shows soot reduced when the circuit was activated. In the third section 516, a circuit was deactivated again showing that more soot is again produced. In the fourth section 518, the circuit was again activated and once again the soot was reduced, in a manner similar to the second section 514. Finally, in the fifth section 520 the circuit was deactivated again showing an increased level of soot production. The amount of change of soot production between the sections where the circuit was active (514, 518) can be easily compared to the sections where the circuit was deactivated (512, 516, 520) by looking at the peaks in the section. For example, it is clear that peaks 532 and 536 where the circuit was active are significantly lower than peaks 530, 534 and 538 where the circuit was deactive. In a similar manner, peaks 542 and 546 are noticeably lower than peaks 540, 544, 548 in the sections where the circuits were deactivated.

In other embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

1. An engine in communication with a power supply for providing a voltage, the engine comprising:
an engine block forming a combustion chamber;
an in-cylinder engine part exposed within the combustion chamber, the engine part being isolated electrically from the engine block; the power supply providing the voltage between the in-cylinder engine part and the engine block.

2. The engine according to claim 1, wherein the voltage has a variable range.

3. The engine according to claim 1, wherein the voltage is between 500 and 5000 volts.

4. The engine according to claim 1, wherein the voltage is a DC voltage.

5. The engine according to claim 1, wherein the voltage is an AC voltage.

6. The engine according to claim 5, wherein the AC voltage has a variable frequency range or voltage range.

7. The engine according to claim 1, wherein the voltage is applied at variable timing or for a variable duration depending on engine operating conditions such as but not limited to engine speed and load.

8. The engine according to claim 1, wherein the voltage is applied during a part of the engine cycle and not applied during another part of the engine cycle.

9. The engine according to claim 1, wherein the positive terminal of the power supply is connected to the in-cylinder engine part.

10. The engine according to claim 1, wherein the in-cylinder engine part is at least one of or a combination of a glow plug, a fuel injector, a valve, a cylinder head, a cylinder head gasket, a spark plug, an ion sensor, a special purpose probe, a new part added to the combustion chamber and a special purpose material positioned on a piston bowl of the combustion chamber.

11. The engine according to claim 1, where an engine controller is configured to send a signal to the power supply to adjust at least one of or a combination of the voltage type (AC or DC), voltage magnitude, voltage duration, voltage frequency, voltage polarity.

12. A method for reducing emission formation and improving fuel consumption in an engine, the engine having an engine block forming a combustion chamber, the method comprising:
providing an in-cylinder engine part exposed within a combustion chamber of the engine;
providing a voltage between the in-cylinder engine part and the engine block.

13. The method according to claim 12, wherein the voltage has a variable range.

14. The method according to claim 12, wherein the voltage is between 500 and 5000 volts.

15. The method according to claim 12, wherein the voltage is a DC voltage.

16. The method according to claim 12, wherein the voltage is an AC voltage.

17. The method according to claim 16, wherein the AC voltage has a variable frequency or voltage range.

18. The method according to claim 12, wherein the voltage is applied at variable timing or for a variable duration depending on engine operating conditions such as but not limited to engine speed and load.

19-21. (canceled)

22. The method according to claim 12, where an engine controller is configured to send a signal to the power supply to adjust at least one of the voltage type (AC or DC), voltage magnitude, voltage duration, voltage frequency, or voltage polarity.

23. The method according to claim 22, where the engine controller is activated to reduce soot emissions.
